(19) United States
(12) Patent Application Publication
(10) Pub. No.: US 2024/0049898 A1
(43) Pub. Date: Feb. 15, 2024

(54) Delivery Box Cabinet

(71) Applicant: Dometic Sweden AB, Solna (SE)

(72) Inventors: Philip Bridge, Hägersten (SE); Mikael Thelin, Huddinge (SE); Peng Wang, Zhuhai (CN)

(21) Appl. No.: 18/264,681

(22) PCT Filed: Dec. 21, 2021
(86) PCT No.: PCT/EP2021/087152

§ 371 Date: Aug. 8, 2023

(30) Foreign Application Priority Data
Feb. 9, 2021 (CN) 202110178659.6

(51) Int. Cl. A47G 29/14; G06Q 10/0836

(52) U.S. Cl. CPC A47G 29/141; G06Q 10/0836; A47G 2029/147

(57) ABSTRACT

The present invention refers to a delivery box cabinet having a mailbox compartment configured to receive and store mailings as letters and small to medium sized parcels, and a therefrom separate food compartment configured to receive and store food deliveries. The delivery box cabinet further comprises a temperature control unit configured to control at least the inside temperature of the food compartment. Thus, deliveries stored within the food compartment can be stored at a preferable temperature increasing the shelf life thereof.

### CLAIM TO PRIORITY

This 35 U.S.C. § 371 National Stage Patent application claims priority to and benefit of PCT Patent Application No. PCT/EP2021/087152, filed Dec. 21, 2021, which claims priority to CN 202110178659.6 filed Feb. 9, 2021, all of which is incorporated by reference herein.

### BACKGROUND

The present embodiments relate to a delivery box for receiving and storing deliveries like mailings and food deliveries.

In recent years, not only the quantity of delivered non-perishable goods such as mailings has increased, but also the quantity of delivered perishable goods, in particular such as food. This includes not only already prepared dishes delivered by a delivery service, but especially also deliveries of whole purchases of non-processed food from corresponding merchants.

When delivered by the delivery service, such deliveries may arrive at the customer's premises at a time when the customer cannot receive them in person. Such a situation may occur when the customer is not at home, for example when the customer is at work. This can further be the case when the customer is busy and may not receive the delivery in person or does not even notice the arrival of the delivery at all, for example if he works in the cellar or garden, for example.

This circumstance is probably impractical for deliveries of non-perishable goods, but in general it is not a major problem there. However, this circumstance is particularly problematic in the case of deliveries of perishable goods, especially of such goods that spoil quickly without proper cooling. Such goods should be cooled constantly in order to guarantee the shelf life of the goods. If the perishable goods are stored by the supplier until they are picked up by the customer or if the perishable goods are deposited at another deposit place until the customer picks them up, such cooling cannot always be guaranteed. Moreover, if the delivered goods are deposited at a deposit place agreed upon with the customer, the safety against theft of the respective goods cannot always be guaranteed.

It is one object of the present disclosure is to provide a solution to these problems.

This is achieved with a delivery box cabinet according to instant disclosure. Advantageous further improvements for such a delivery box compartment are also presented.

### SUMMARY

According to the instant embodiments, a delivery box cabinet for receiving and storing deliveries comprises at least a first delivery compartment and a second delivery compartment. The first delivery compartment is a mailbox compartment configured to receive and store mailings like letters and small to medium sized parcels. The second delivery compartment is a food compartment configured to receive and store food deliveries. The food compartment is different from the mailbox compartment. The delivery box cabinet is characterized in that it comprises a temperature control unit configured to control at least the inside temperature of the food compartment.

Within the scope of the present embodiments the term “control” has the meaning of “regulate”. Thus, the temperature control unit is configured to set and to vary the temperature within the food compartment, i.e. the temperature control unit is configured to increase and/or decrease the temperature within the food compartment. This configuration allows the user to optimize the temperature within the food compartment to extend the shelf life of food stored therein.

The temperature control unit is a cooling unit configured to actively cool the inside of the food compartment. Such a configuration is highly functional as in most situations, an appropriate cooling of food deliveries is the most critical aspect when storing such goods.

Further, the mailbox compartment, the food compartment and the temperature control unit are provided as distinct modular components being coupled to each other by fastening means. Such a modular implementation facilitates the maintenance of the distinct components of the delivery box cabinet. Moreover, the modular implementation facilitates specific adaptions of the delivery box cabinet by replacing one of the components by another being more suitable according to user's current requirements.

The mailbox compartment, the food compartment and the temperature control unit are enclosed at least partially by a common outer frame and/or housing. In particular the outer frame and/or housing is configured in a weatherproof manner. The outer frame and/or housing is made of stainless steel. Thus, it is possible to set up and operate the delivery box cabinet in an outdoor environment without damages to the delivery box cabinet or its functionality due to environmental influences like weather or the like.

The delivery box cabinet further comprises at least one locking unit configured to lock the mailbox compartment and/or the food compartment. Such a configuration allows to protect deliveries stored in the respective delivery compartments form theft.

Further, the mailbox compartment comprises a mailbox compartment door configured to be moved between an opened state and a closed state and which allows to open or to close the mailbox compartment. The mailbox compartment further comprises a mailbox compartment locking unit configured to lock the mailbox compartment door in the closed state. The food compartment comprises a food compartment door configured to be moved between an opened state and a closed state and which allows to open or to close the food compartment. The food compartment further comprises food compartment locking unit configured to lock the food compartment door in the closed state. Thus, the inner of the two delivery compartments can be accessed easily by a delivery person or user while at the same time ensuring protection of the deliveries within the delivery compartments against unintended removal or theft.

Further, the mailbox compartment locking unit and the food compartment locking unit can be locked and unlocked separately from each other. This results in a highly flexible locking configuration.

Further, the mailbox compartment locking unit and/or the food compartment locking unit comprises one of a mechanical lock or electronic lock. Such configurations are highly functional and technically well developed.

Further, the mechanical lock is configured such that it can be locked and unlocked with a locking unit key. A mechanical locking unit with a mechanical locking unit key is quite simple in structure and reliable in function.

Further, the electronic lock comprises an electronic user interface device, in the form of a keypad. The electronic user interface device is configured to receive input commands from a user to control the electronic lock. Such a user interface is functional and versatile.

Further, the food compartment locking unit is provided in such a manner that it can be reached and/or controlled by a user only from the inside of the mailbox compartment. Thus, the food compartment locking unit is protected from environmental influences, like for example pollution, and from unauthorized access.

Further, the food compartment comprises at least two food compartment doors, wherein each food compartment door is provided on a different side of the food compartment. The food compartment further comprises two food compartment locking units, wherein each food compartment locking unit is configured to lock only one of said two food compartment doors. Thus, it is possible to access the food compartment from two sides, wherein both compartments doors can be locked in an appropriate manner.

The delivery box cabinet further comprises a communication and control unit. The communication and control unit is coupled to at least one electrical component of the delivery box cabinet, for example the communication and control unit is coupled to the controller of the temperature control unit. The communication and control unit is configured to exchange information and control data with the at least one of the various electrical components of the delivery box cabinet. Furthermore, the communication and control unit is configured to be coupled to an external device like a smart phone or a tablet. Such a central communication and control unit increases the versatility of the delivery box cabinet and facilitates the operation thereof.

Further, the communication and control unit is configured to be coupled wirelessly to the external device. Thus, the external device can be operated spatially independent of the delivery box cabinet.

Further, the communication and control unit is configured to obtain status information about the mailbox compartment and/or the food compartment, for example lock state information, filling level information and/or temperature information. Moreover, the communication and control unit is configured to forward the status information to said external device. Thus, the forwarded information can be displayed on the external device to inform the user correspondingly.

Further, the communication and control unit is configured to receive and to process control information like temperature control information, lock control information and/or alarm control information as control data from said mobile external device. Thus, a versatile central communication and control unit is formed.

Further, the delivery box cabinet comprises an alarm unit, and the communication and control unit is configured to control the alarm unit. Such an alarm unit can serve to inform a user of the occurrence of specific situations like a filling of one the delivery cabinets, the occurrence of an error while operating any component of the delivery box cabinet or other situations. Thus, the user is informed of various specific situations and status changes in a reliable manner.

### BRIEF DESCRIPTION OF THE DRAWINGS

A more complete appreciation of the present embodiments and many of the attendant advantages thereof will be readily obtained as the same becomes better understood by reference to the following detailed description when considered in connection with the accompanying drawings, wherein:

FIG. 1 is a perspective front view of a delivery box cabinet according to an exemplary embodiment of the present embodiments;

FIG. 2 is a perspective back view of the delivery box cabinet of FIG. 1;

FIG. 3 is a perspective front view of the delivery box cabinet of FIG. 1 in a partially disassembled state;

FIG. 4 is a perspective partial front view of the partially disassembled delivery box cabinet of FIG. 3;

FIG. 5 is a perspective partial top view of the delivery box cabinet of FIG. 1 in another partially disassembled state;

FIG. 6 is a perspective partial back view of the delivery box cabinet of FIG. 1 in another partially disassembled state; and

FIG. 7 is a perspective partial front view of the delivery box cabinet of FIG. 6.

### DETAILED DESCRIPTION

An exemplary embodiment will now be described with reference to the accompanying drawings, wherein identical reference numerals designate identical elements throughout the various drawings.

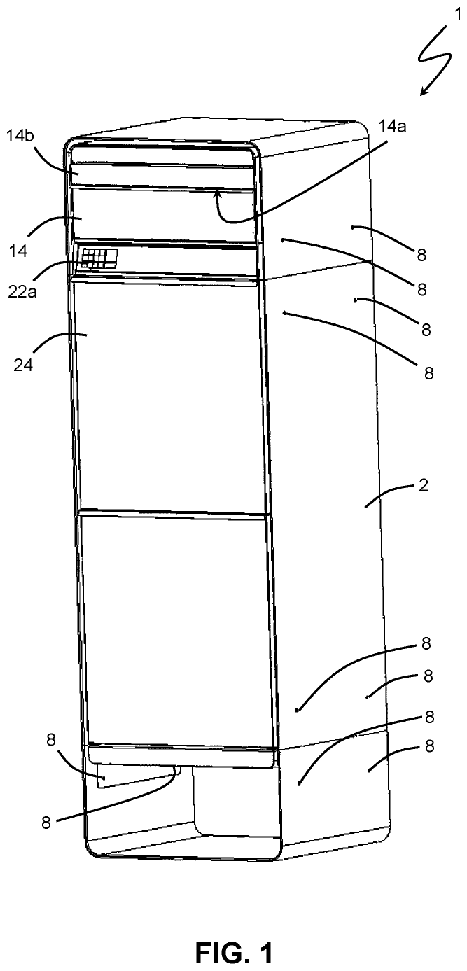

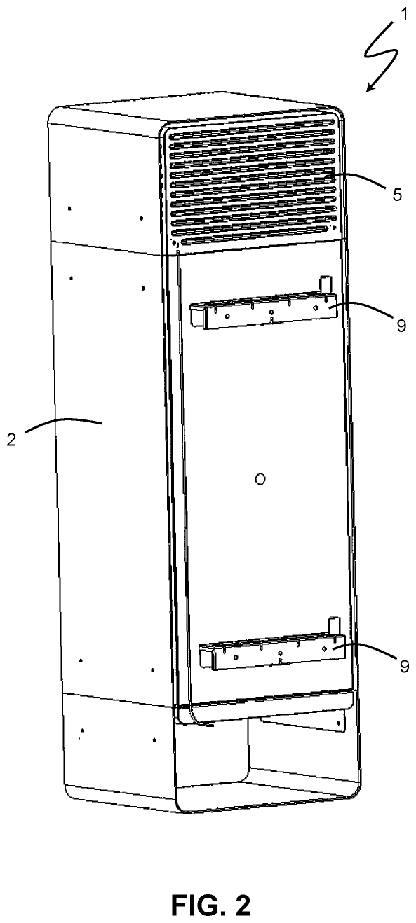

FIG. 1 shows a perspective front view of the exemplary delivery box cabinet 1 according to one embodiment of the present invention. FIG. 2 shows a perspective back view of the delivery box cabinet 1.

As can be seen in FIGS. 1 and 2, the delivery box cabinet 1 comprises an outer frame or housing 2 and at least two compartment doors 14 and 24. The at least two compartment doors 14 and 24 are coupled to the outer frame or housing 2 of the delivery box cabinet 1. Each of the two compartment doors 14 and 24 is coupled to the outer frame or housing 2 in a pivotal manner such that each compartment door 14 or 24 can be moved between a closed state and an opened state with respect to the outer frame or housing 2. The compartment doors 14 or 24 can be moved independently of each other.

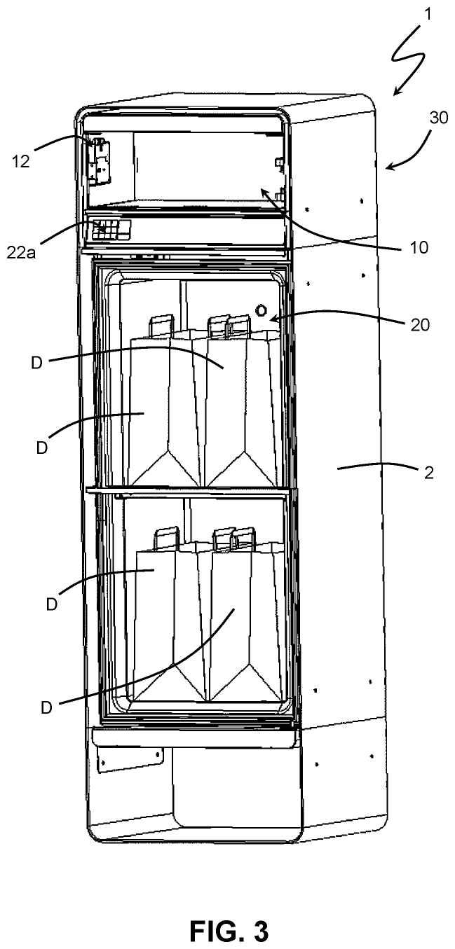

As shown in FIG. 3 in which the compartment doors 14 and 24 have been omitted, the delivery box cabinet 1 comprises a first delivery compartment 10 and a second delivery compartment 20. In the illustrated drawings, the second delivery compartment 20 is filled with deliveries D, here in the form of bags filled with food. The deliveries D and/or the bags are obviously no components of the delivery box cabinet 1 itself. The first delivery compartment 10 is a mailbox compartment 10 configured to receive and store mailings such as letters and/or small to medium sized parcels. The second delivery compartment 20 is a food compartment configured to receive and store deliveries D containing food.

It is to be highlighted that said two delivery compartments 10 and 20 are different from each other and depict individual components of the delivery box cabinet 1. In the following, the first delivery compartment 10 will be referred to as mailbox compartment 10 and the second delivery compartment 20 will be referred to as food compartment 20.

The first compartment door 14 is configured to seal the mailbox compartment. Thus, in the following the first compartment door 14 is referred to as mailbox compartment door 14. Here, the mailbox compartment 10 is positioned vertically on top of the food compartment 20 such that commonly quite large and heavy food deliveries can be loaded within the food compartment 20 in an easy and comfortable manner, while at the same time mailings can be loaded to the mailbox compartment 10 in an easy and comfortable manner as well. The second compartment door 24 is configured to seal the food compartment 20. Thus, in the following the second compartment door 24 is referred to as food compartment door 24. The specific configuration of the two compartment doors 14 and 24 and the thereto related components will be discussed below in more detail.

The delivery box cabinet 1 further comprises a temperature control module 30 or temperature control unit 30. The temperature control module 30 is configured to control at least the temperature within the inner of the food compartment 20. The temperature control module 30 is provided within a temperature control module receiving configuration 4. Here, the temperature control module receiving configuration 4 is configured as receiving section located behind the mailbox compartment 10 on top of the rear side of the food compartment 20. This configuration is space efficient as the mailbox compartment 10 does not need as much space as the food compartment 20 in the depth. Thus, the final configuration is quite compact while the original functions of the mailbox compartment 10 and of the food compartment 20 are not impaired by the temperature control module 30.

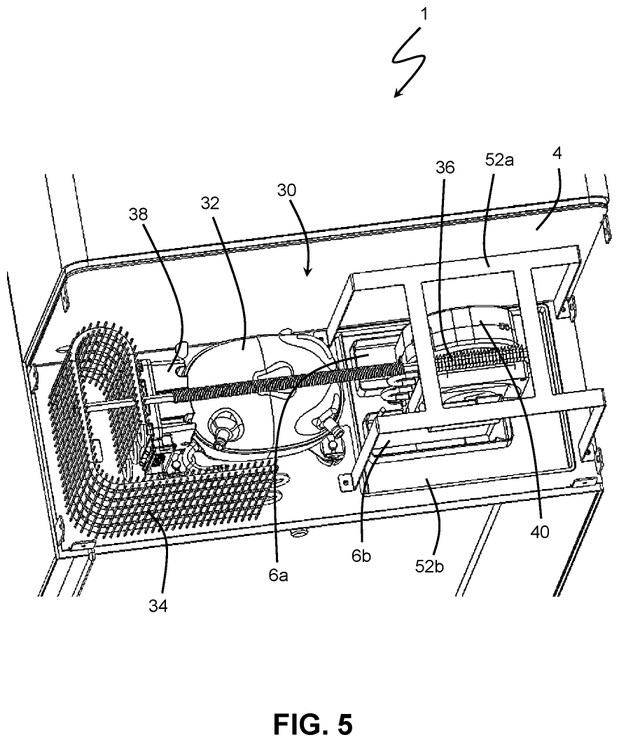

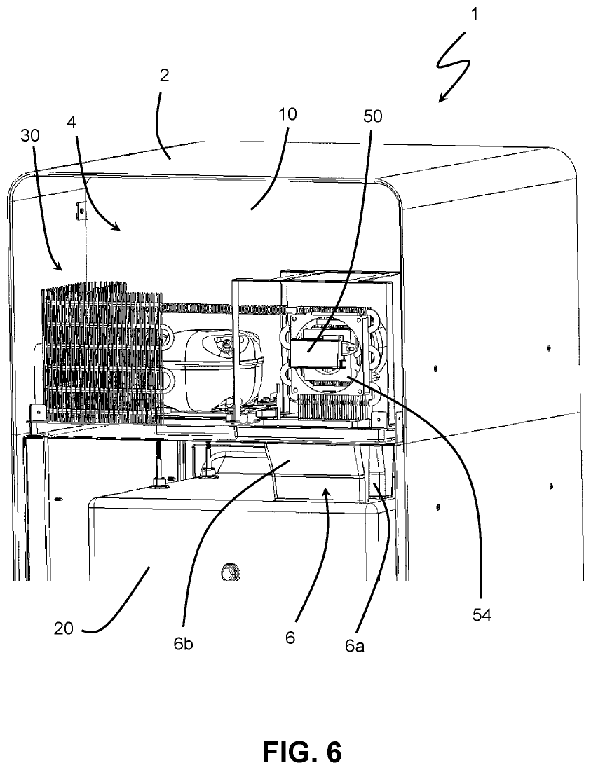

As can be seen in FIG. 2 in view of FIGS. 5 and 6, the temperature control module 30 is enclosed by the frame or housing 2 and a further provided ribbed cover plate 5. The cover plate 5 shields the temperature control module 30 from external influences but allows a temperature exchange between the temperature control module 30 and the environment of the delivery box cabinet 1.

In the illustrated embodiment, the mailbox compartment 10, the food compartment 20 and the temperature control module 30 are provided as distinct modular components which are coupled to each other by suitable fastening means 8, for example screws. In the assembled state of the delivery box cabinet 1 the mailbox compartment 10, the food compartment 20 and the temperature control module 30 are enclosed by the common outer frame or housing 2. The outer frame or housing 2 is provided in a weatherproof manner, for example being made of stainless steel or other suitable materials. This allows to set up the delivery box assembly 1 outdoors without the need of providing a further weather protection for the delivery box assembly 1.

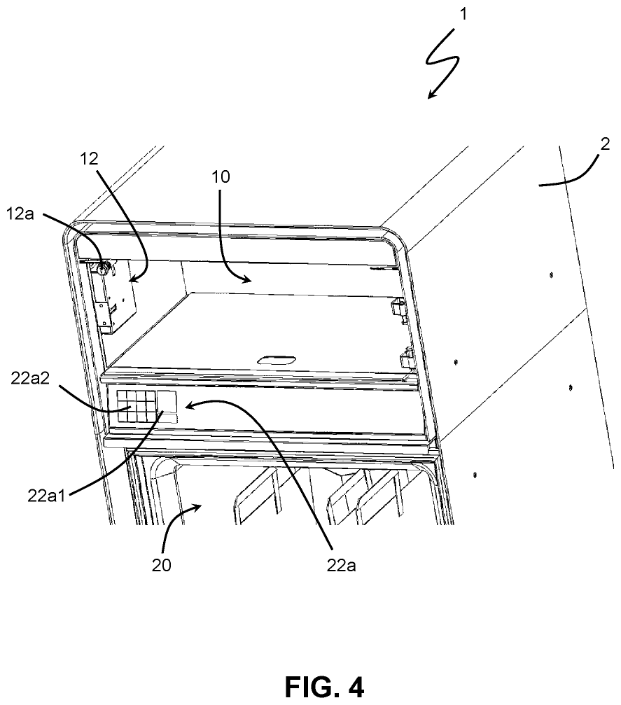

As can be seen in particular in FIG. 4, the delivery box cabinet 1 comprises a mailbox compartment locking unit 12. The mailbox compartment locking unit 12 is configured to lock the mailbox compartment door 14 in the closed state thereof and thus to lock the mailbox compartment 10. Here, the mailbox compartment locking unit 12 is provided in the form of a mechanical lock configured to be locked and unlocked with a physical mailbox compartment locking unit key (not illustrated). The key has to be inserted into a mailbox compartment locking unit keyhole 12a of the mailbox compartment locking unit 12. As such mechanical locking units 12 are well known in the art and the concrete structural and functional configuration thereof will not be described in detail here.

Moreover, the delivery box cabinet 1 comprises a food compartment locking unit 22. The food compartment locking unit 22 is configured to lock the food compartment door 24 in the closed state and thus to lock the food compartment 20. Here, the food compartment locking unit 22 is provided in the form of an electronic lock configured to be locked and unlocked via an electronic user interface 22a. In the illustrated embodiment the electronic user interface 22a is provided in the form of a keypad. The user interface 22a comprises a display section 22a1 for displaying various information and an input section 22a2 for inputting control commands by the user. As such electronic locking units are well known in the art and the concrete structural and functional configuration thereof will not be described in detail here.

It is to be noted that the two compartment locking units 12 and 22 are provided in such a manner that they can be locked and unlocked separately from each other. In other words, the locking state of the mailbox compartment locking unit 12 is not linked to the locking state of the food compartment locking unit 22 and vice versa.

In the illustrated embodiment, the mailbox compartment door 14 defines a mailing insertion slot 14a. The mailing insertion slot 14a allows access to the interior of the mailbox compartment 10 at least in a limited manner through the mailbox compartment door 14, even when the compartment door 14 is in the closed state. Such a configuration is quite common for mailbox compartment doors 14 and thus has not to be described in detail. An insertion flap 14b is configured and coupled to the mailbox compartment door 14 in such a manner that it can be moved between a first position and a second position. In the first position the insertion flap 14b covers the mailing insertion slot 14a. In the second position the insertion flap 14b does not cover the mailing insertion slot 14a. Such a configuration is, at least in principle, well known and is, thus, not described in detail here.

As can be seen in FIG. 4 together with FIG. 1, the mailbox compartment locking unit keyhole 12a is arranged such that in the closed state of the mailbox compartment door 14 it is positioned within the mailing insertion slot 14a and covered by the insertion flap 14b. Thus, the mailbox compartment locking unit keyhole 12a is protected against water and dirt from the environment of the delivery box cabinet 1. This improves longtime performance of the mailbox compartment locking unit 12. To insert the locking unit key into said mailbox compartment locking unit keyhole 12a, the insertion flap 14b has to be moved into its second position.

In the illustrated embodiment, the user interface 22a of the food compartment locking unit 22 is arranged on a tilted surface on the front side of the delivery box cabinet 1 in such a manner that it can be operated by the user independently of the opening state of the mailing compartment door 24. However, the user interface 22a can also be provided in such a manner that is can be operated by a user only from the inside of the mailbox compartment 10. In other words, the electronic user interface 22a can be positioned within the mailbox compartment 10 in such a manner that the mailbox compartment door 14 has to be in the open state to enable a user to operate the user interface 22a and, thus, to control the food compartment locking unit 22. Such a configuration results in more security for the deliveries stored in the food compartment 20.

As can be seen in FIG. 2, the delivery box cabinet 1 of the illustrated embodiment comprises two anchoring components 9 arranged on the back of the delivery box cabinet 1. The anchoring components 9 are configured to anchor the delivery box cabinet 1 to a suitable anchoring structure, for example like a wall of a building. Alternatively, similar anchoring components can be provided on a bottom of the delivery box cabinet 1 or such anchoring components could be omitted completely.

At this point, it is noted that although in the illustrated embodiment only one mailbox compartment door 14 and only one food compartment door 24 are provided on the front side of the delivery box cabinet 1, more than one mailbox compartment door 14 and/or more than one food compartment door 24 can be provided. Further compartment doors not have to be arranged just for further compartments, but they can also be configured to seal the above discussed mailbox compartment 10 or the food compartment 20. In particular, such further compartment doors can be arranged on a back side of the provided delivery compartments 10 and 20 such that the various compartments 10 and 20 can be accessed also from the other side of the delivery box cabinet 1. Such a configuration is of particular relevance in situations in which the delivery box cabinet 1 is not set up in front of a wall of the user's house but, for example, within an aperture in a wall of the house. Thus, the compartments 10 and 20 can be loaded from outside the house, while the compartments 10 and 20 can be emptied from within the house by a user in an easy and comfortable manner. Of course, the additional compartment doors can be provided with further compartment locking units configured to lock each additional compartment door individually. Also, some of the compartment locking units can be operatively coupled to each other or can be integrally formed. A skilled artisan will be able to think of various door configurations.

Although not illustrated explicitly, the delivery box cabinet 1 further comprises a communication and control unit. The communication and control unit is coupled to at least one electrical component of the delivery box cabinet 1. Examples for such electrical components are the food compartment locking unit 22 or the temperature control module 30. Further examples for such electrical components are various sensor units, like for example temperature sensors or laser barriers, or a further provided alarm unit configured to launch an alarm in specific critical situations, for example like damages of some of the components of the delivery box cabinet 1, or less critical situations, for example like delivery compartments 10 and/or 20 being fully loaded. Here, the communication and control unit is further configured to be coupled to an external device, for example like a smart phone or tablet, and to communicate therewith, in particular in a wireless manner. Alternatively, configurations in which the external device is coupled to the communication and control unit of the delivery box cabinet 1 via a cable and corresponding connectors are possible.

In the present embodiment the communication and control unit is configured to obtain several status information about the mailbox compartment 10 and the food compartment 20 and to forward these status information to the external device. The status information include lock state information indicating the current state of the provided compartment locking units 12 or 22, filling state information indicating whether the various delivery compartments 10 and 22 are empty or loaded and temperature information indicating the current temperature within the delivery compartments 10 and 20. For determining such information corresponding sensors units, in particular including laser sensors and/or temperature sensors, are provided within the delivery box cabinet 1. Furthermore, the communication and control unit is configured to receive and to process control information from the external device and to control at least some of the electrical components coupled to the communication and control unit based on the processed control information. Alternatively, or in addition thereto, the communication and control unit according to the present embodiment can receive control information input by a user in the user interface 22a. Examples for such control information are temperature control information indicating a target temperature for at least one of the delivery compartments 10 and 20, lock control information indicating a desired lock state for at least one of the locking units 12 and 22 and/or alarm control information indicating a desired operation state like armed or disarmed for the provided alarm unit.

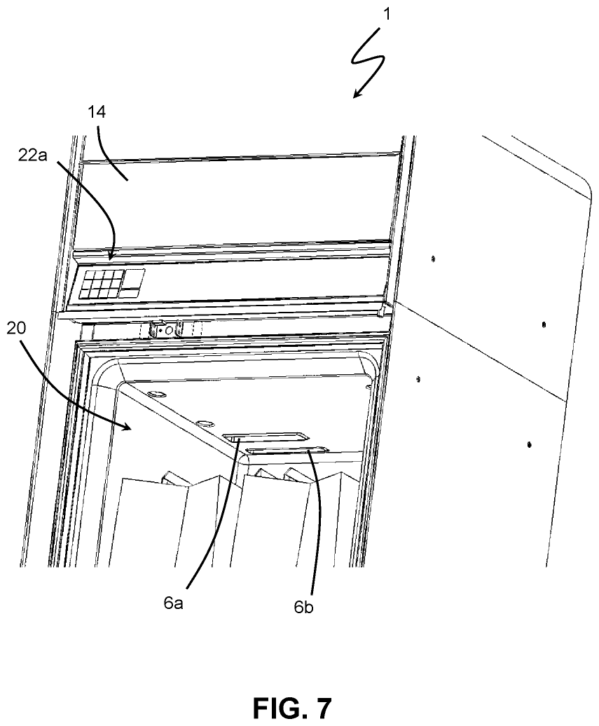

In the following, the specific configuration of the temperature control unit 30 will be described in detail with respect to FIGS. 5 to 7.

In the illustrated embodiment, the temperature control module or unit 30 is configured to serve as cooling unit. However, the temperature control module or unit 30 could be also adapted to be used as heating unit. Moreover, the temperature control module or unit 30 is provided in a compact block-like manner as a, in principle, self-contained component which is installed in the temperature control module receiving configuration 4 of the delivery box cabinet 1. The temperature control module 30 is arranged behind the mailbox compartment 10 on top of the rear side of the food compartment 20. Thus, a very compact overall configuration for the delivery box cabinet 1 is achieved.

The temperature control module 30 comprises a compressor 32, a condenser 34 and an evaporator 36 forming an absorption cooling circuit in a known manner. Furthermore, the temperature control module 30 comprises a controller 50 to control the operation of the temperature control module 30 and in particular of the compressor 32. Moreover, the temperature control module 30 comprises a condenser fan unit 38 and an evaporator fan unit 40. The condenser fan unit 38 is configured to generate a first air flow at the condenser 34 to enhance the temperature exchange capacity at the condenser 34. The evaporator fan unit 40 is configured to generate a second air flow at the evaporator 36 to enhance the temperature exchange capacity at the evaporator 40. The temperature control module 30 further comprises an air flow guiding configuration 52 separating the first air flow from the second air flow. Here, the air flow guiding configuration 52 comprises a housing (not illustrated) enclosing the evaporator 36 and the evaporator fan unit 40. The air flow guiding configuration 42 comprises a frame 52a for supporting the housing and a coupling unit 52b configured to be coupled to an air flow guiding arrangement 6.

In the illustrated embodiment, the air flow guiding arrangement 6 comprises a first air flow guide 6a and a second air flow guide 6b. The first air flow guide 6a and a second air flow guide 6b are provided in such a manner that they connect the inner of the food compartment 20 with the inner of the air flow guiding configuration 52 and thus with the evaporator 36 and the evaporator fan unit 40. The evaporator fan unit 40 is configured to draw air through the first air flow guide 6a from the inner of the food compartment 20 to the evaporator 36 for temperature exchange with the evaporator 36 and then back through the second air flow guide 6b into the food compartment 20. Here, the temperature control module 30 comprises a purification unit 54. The purification unit 54 is positioned within the air flow path between the first air flow guide 6a and the second air flow guide 6b within the air flow guiding configuration 52. The purification unit 54 is configured to purify air traveling through the air flow guiding configuration 42. An example for such a purification unit 54 is a simple air filter or more a complex configuration like an electro filter which can be activated and deactivated via a purification control unit. Here, the controller 50 for the overall temperature control unit 30 is provided on the purification unit 54 resulting in a compact configuration. A purification control unit can be implemented as logic section of the controller 50 to save further space. Further, a purification control unit can be configured to operate the purification unit 54 according to a predetermined operation schedule based, for example, on time information and/or signals received form further provided sensors. The housing of the air flow guiding configuration 52 is formed in a thermally insulating manner to thermally decouple the condenser 34 and the evaporator 36 from each other.

The provided air flow guides 6a and 6b, and possibly further provided air flow guides, can be configured and arranged such that they define various separate temperature zones within the delivery box cabinet 1. As such configurations are quite numerous and a skilled artisan will have no problems in implementing such configurations, further details will not be described.

Finally, it is pointed to the fact that the above described embodiments depict an implementation of the present embodiments. The corresponding explanations have been provided to explain the present embodiments and features in an illustrative manner. However, the exemplary embodiments should not be read and understood as limiting the accompanying set of claims. A skilled artisan will be able to find various modifications for the above described embodiment without leaving the scope of protection as defined by the accompanying set of claims.

### REFERENCE NUMERALS

1 delivery box cabinet
2 frame and/or housing
4 temperature control module receiving configuration
5 cover plate
6 air flow guiding arrangement
6a first air flow guide
6b second air flow guide
8 fastening means
9 anchoring components
10 first delivery compartment/mailbox compartment
12 mailbox compartment locking unit
12a mailbox compartment locking unit keyhole
14 mailbox compartment door
14a mailing insertion slot
14b insertion flap
20 second delivery compartment/food compartment
22 food compartment locking unit
22a user interface
22a1 display section
22a2 input section
24 food compartment door
30 temperature control unit/temperature control module
32 compressor
34 condenser
36 evaporator
38 condenser fan unit
40 evaporator fan unit
52 air flow guiding configuration
52a frame
52b coupling unit
54 purification unit
D deliveries

1. A delivery box cabinet for receiving and storing deliveries, wherein the delivery box cabinet comprising:
at least a first delivery compartment being a mailbox compartment configured to receive and store mailings, and
a second delivery compartment being a food compartment configured to receive and store food deliveries, wherein the food compartment is different from the mailbox compartment,
wherein the delivery box cabinet further comprises a temperature control unit configured to control at least the inside temperature of the food compartment.

2. The delivery box cabinet of claim 1,
wherein the temperature control unit is a cooling unit configured to cool the inside of the food compartment actively.

3. The delivery box cabinet of claim 1, wherein the mailbox compartment, the food compartment and the temperature control unit are provided as distinct modular components being coupled to each other by fastening means.

4. The delivery box cabinet of claim 1, wherein
the mailbox compartment, the food compartment and the temperature control unit are enclosed at least partially by a common outer frame and/or housing,
wherein said outer frame and/or housing in particular is configured in a weatherproof manner,
wherein said outer frame and/or housing is made of stainless steel.

5. The delivery box cabinet of claim 1,
wherein the delivery box cabinet further comprises at least one locking unit configured to lock the mailbox compartment and/or the food compartment.

6. The delivery box cabinet of claim 5,
wherein the mailbox compartment comprises a mailbox compartment door configured to be moved between an opened state and a closed state to open and to close the mailbox compartment, and a mailbox compartment locking unit configured to lock the mailbox compartment door in the closed state, and
wherein the food compartment comprises a food compartment door configured to be moved between an opened state and a closed state to open and to close the food compartment, and a food compartment locking unit configured to lock the food compartment door in the closed state.

7. The delivery box cabinet of claim 6,
wherein the mailbox compartment locking unit and the food compartment locking unit can be locked and unlocked separately of each other.

8. The delivery box cabinet of claim 6,
wherein the mailbox compartment locking unit and/or the food compartment locking unit comprises one of a mechanical lock or electronic lock.

9. The delivery box cabinet of claim 8,
wherein the mechanical lock is configured such that said mechanical lock can be locked and unlocked with a locking unit key.

10. The delivery box cabinet of claim 8,
wherein the electronic lock comprises an electronic user interface device, preferably in from of a keypad, configured to receive input commands from a user to control the electronic lock.

11. The delivery box cabinet of claim 5,
wherein the food compartment locking unit is provided in such a manner that it can be reached and/or controlled by a user just from the inside of the mailbox compartment.

12. The delivery box cabinet of claim 5,
wherein the food compartment comprises at least two food compartment doors, each food compartment door being provided on a different side of the food compartment, and two food compartment locking units, wherein each food compartment locking unit is configured to lock only one of said two food compartment doors.

13. The delivery box cabinet of claim 1,
wherein the delivery box cabinet further comprises a communication and control unit, wherein the communication and control unit is coupled to at least one electrical component of the delivery box cabinet and is configured to exchange information and control data with the at least one of the various electrical components of the delivery box cabinet, and
wherein the communication and control unit is further configured to be coupled to an external device.

14. The delivery box cabinet of claim 13,
wherein the communication and control unit is configured to be coupled wirelessly to the external device.

15. The delivery box cabinet of claim 13,
wherein the communication and control unit is configured to obtain status information about the mailbox compartment and/or the food compartment like lock state information, filling level information and/or temperature information, and wherein the communication and control unit is configured to forward the status information in to the external device.

16. The delivery box cabinet of claim 13,
wherein the communication and control unit is configured to receive and to process control information like temperature control information, lock control information and/or alarm control information as control data from said mobile external device.

17. The delivery box cabinet of claim 16,
wherein the delivery box cabinet further comprises an alarm unit, and the communication and control unit is configured to control the alarm unit.

18. The delivery box cabinet of claim 1, wherein said mailings are one of letters or small to medium sized parcels.
